(19) United States
(12) Patent Application Publication
(10) Pub. No.: US 2008/0230149 A1
(43) Pub. Date: Sep. 25, 2008

(54) Work feeding and conveying mechanism for a planing machine

(76) Inventor: Bor-Yann Chuang, Taiping City (TW)

Correspondence Address: BRUCE H. TROXELL, SUITE 1404, 5205 LEESBURG PIKE, FALLS CHURCH, VA, 22041, US

(21) Appl. No.: 11/723,772

(22) Filed: Mar. 22, 2007

(51) Int. Cl. B27C 1/12

(52) U.S. Cl. 144/128

(57) ABSTRACT

A work feeding and conveying mechanism for a planing machine includes a conveying device having a conveying belt fitted around an intermediate base and actuated to rotate by a front shaft. The front shaft has one side secured with a driven gear connected with a transmission device, which has a gear set driven to rotate by a knife shaft assembled on an upper base. The gear set has its lower side fixed with a transmission shaft coupled with a transmission set positioned at the outer side of the intermediate base. The transmission set has one side extending outward and fixed with a transmission gear connected with the driven gear of the front shaft. The conveying device can be driven to rotate and smoothly convey a work piece with a comparatively large contact area, able to carry out wood planing process with precision.

### BACKGROUND OF THE INVENTION

1. Field of the Invention

This invention relates to a work feeding and conveying mechanism for a planing machine, particularly to one provided with a conveying device on an intermediate base of a planing machine. The conveying device can be actuated to operate by a transmission device that is coupled with a knife shaft. Thus, a work can be steadily and smoothly conveyed by the. conveying device to be processed with precision.

2. Description of the Prior Art

A conventional planing machine 10, as shown in FIG. 1, includes a flat top planing table 11 having an intermediate base 12 and an upper base 13 assembled thereon. The intermediate base 12 is a flat stand having its upper end pivotally disposed with two rollers 121, and the upper base 13 is provided thereon with a rotary arm 131 able to control and adjust the distance between the intermediate base 12 and the upper base 13. Further, the upper base 13 is pivotally installed with a planing knife 132 in the interior to be driven by a motor (not shown) to carry out planing a work. The planing knife 132 has its front and rear side respectively and pivotally disposed with a press-convey roller 133 driven to roll by the motor. When the press-convey rollers 133 are rotated, a work will be drawn forward to be processed from the front end of the intermediate base 12 and after planed into a needed thickness, and will be sent out from the rear end of the intermediate base 12.

However, the two press-convey rollers 133 of the conventional planning machine are respectively positioned at the front and the rear side of the planing knife 132; therefore, when a work is pressed and conveyed, the press-convey rollers 133 and the surface of the work will contact linearly. Thus, when pressed by one press-convey roller 133, the work, due to insufficient support force of the press-convey roller 133, cannot be entirely pressed evenly. In this case, during planing, the front and the rear end of the work may become slightly curved and consequently the work can hardly be planed evenly and smoothly. In addition, as shown in FIG. 2, in order to enable the motor to simultaneously drive both the planing knife 132 and the roller 133, which are quite different in function and in rotating speed, a speed-reducing unit 134 composed of plural gears has to be additionally installed between the planning knife 132 and the rollers 133 for mutual interaction, but the speed-reducing unit 134 is complicated in structure and not easy in maintenance, resulting in the size increased and a higher cost of a planning machine.

### SUMMARY OF THE INVENTION

The objective of this invention is offer a work feeding and conveying mechanism for a planing machine, which includes a conveying device assembled on an intermediate base of a planing machine. The conveying device consists of a front shaft, a rear shaft and a conveying belt. The front shaft is fixed at the front end of the intermediate base, having one end extending outward and assembled thereon with a driven gear connected with a transmission device to be actuated to rotate. The rear shaft is pivotally assembled at the rear end of the intermediate base, able to be actuated to move back and forth horizontally for a preset distance. The conveying belt is fitted around the intermediate base and passes on both the front and the rear shaft, having a rough surface with high friction coefficient. The transmission device consists of a gear set, a transmission shaft and a transmission unit. The gear set is combined with the upper base of the planing machine and coupled with a knife shaft inside the upper base, having its lower side coupled with the transmission shaft, which has the other end connected with the transmission unit positioned at one side of the intermediate base. The transmission unit has one end protruding outward and fixed thereon with a transmission gear coupled with the driven gear of the front shaft of the conveying device. The conveying belt of the conveying device is driven to rotate to feed and convey a work; therefore, when a wood work is conveyed by the conveying belt, its contact and pressed area becomes comparatively large, thus enabling the wood work to be conveyed smoothly and processed precisely. In addition, the transmission device coupled with the knife shaft is driven to operate by the knife shaft, so it is needless to additionally provide any extra power, able to elevate market competitive force.

### BRIEF DESCRIPTION OF DRAWINGS

This invention will be better understood by referring to the accompanying drawings, wherein:

FIG. 1 is a front cross-sectional view of a conventional planing machine;

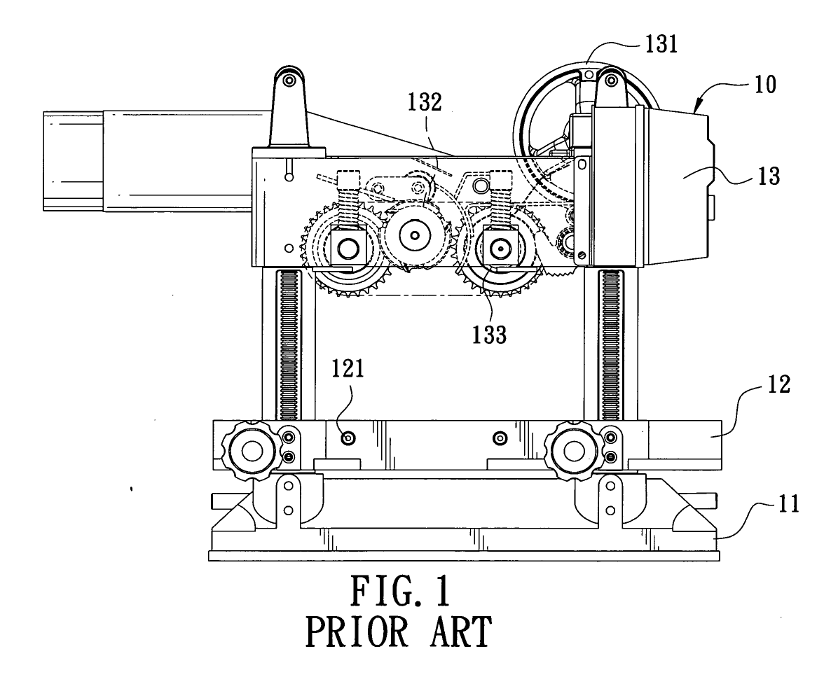

FIG. 2 is a rear cross-sectional view of the conventional planing machine;

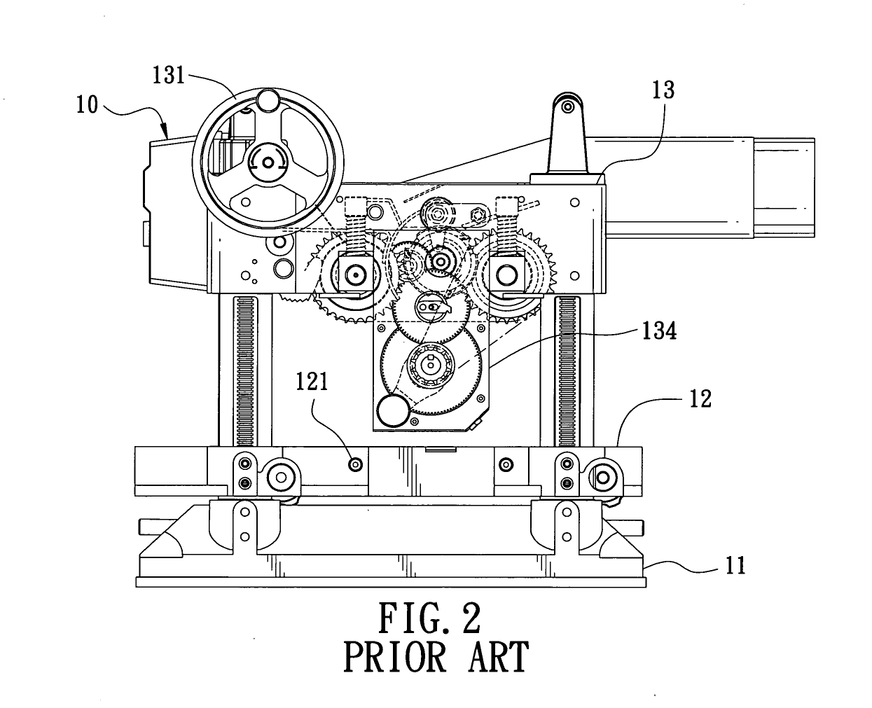

FIG. 3 is a perspective view of a first preferred embodiment of a work feeding and conveying mechanism for a planing machine in the present invention;

FIG. 4 is a partial exploded perspective view of a conveying device in the present invention;

FIG. 5 is a partial exploded perspective view of a transmission device in the present invention;

FIG. 6 is an upper view of the gear set of the transmission device in the present invention;

FIG. 7 is a side cross-sectional view of the first preferred embodiment of the work feeding and conveying mechanism for a planing machine in the present invention; and

FIG. 8 is a perspective view of a second preferred embodiment of a work feeding and conveying mechanism for a planing machine in the present invention.

### DETAILED DESCRIPTION OF THE PREFERRED EMBODIMENT

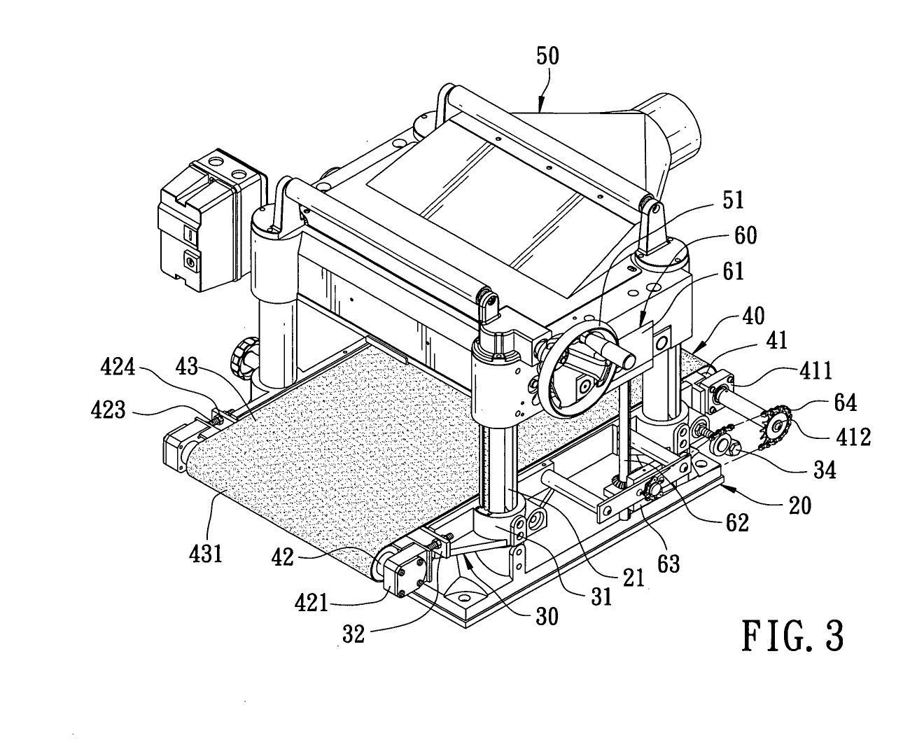

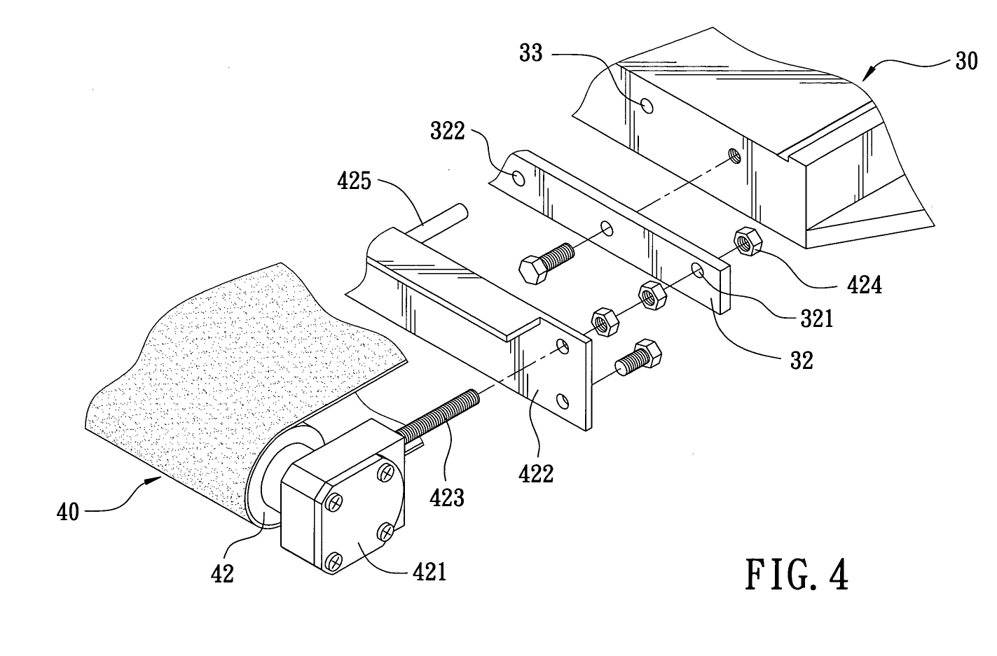

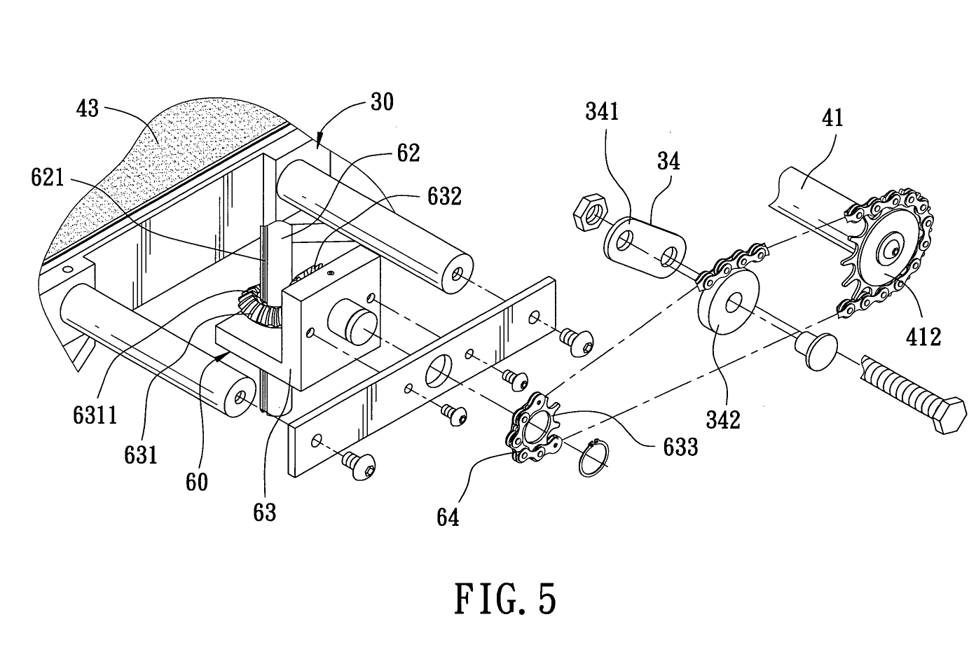

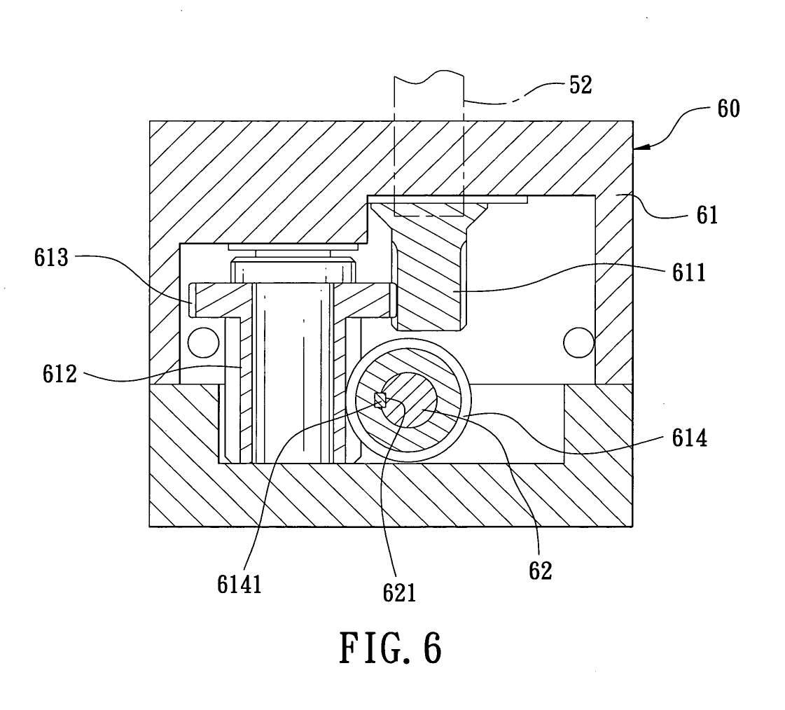

A first preferred embodiment of a work piece feeding and conveying mechanism for a planing machine in the present invention, as shown in FIGS. 3-7, includes a planing table 20, an intermediate base 30, a conveying device 40, an upper base 50 and a transmission device 60 as main components combined together.

The planing table 20 with a flat upper surface has its periphery fixed with four threaded rods 21 spaced apart and extending upward vertically and its interior installed with a motor (not shown) for producing power.

The intermediate base 30 has its periphery formed with four projections spaced apart and respectively bored with a vertical threaded hole 31 to be respectively and pivotally around the lower end of each threaded rod 21 of the planing table 20. The intermediate base 30 further has its rear end provided with a projecting block 32 having its opposite ends respectively extending out of the intermediate base 30. The projecting block 32 has its opposite ends respectively bored with a through hole 321 and its central portion bored with two slide holes 322. Further, the intermediate base 30 has the central portion of its rear wall bored with two recessed insert holes 33 matching with the two slide holes 322 of the projecting block 32 and has one side pivotally connected with an idle wheel unit 34 composed of an adjusting rod 341 and an idle wheel 342 that is pivotally connected to one end of the adjusting rod 341, which has the other end pivotally positioned on the intermediate base 30 and adjustable in position.

The conveying device 40 mounted on the intermediate base 30 is composed of a front shaft 41, a rear shaft 42 and a conveying belt 43. The front shaft 41 is secured at the front end of the intermediate base 30 by means of two bearing seats 411 and has one end extending outward and assembled thereon with a driven gear 412. The rear shaft 42 is fixed at the read end of the intermediate base 30 by two bearing supports 421 having their front ends secured with a connecting plate 422, which has its opposite ends respectively provided with an adjusting rod 423 extending forward and inserted through the through hole 321 of the projecting block 32 of the intermediate base 30, with two nuts 424 respectively positioned at the opposite sides of the through hole 321 and screwed on the adjusting rod 423. Further, the connecting plate 422 has its lower portion disposed with two slide rails 425 extending outward horizontally to be respectively inserted through the two slide holes 322 and positioned in the two recessed insert holes 33 of the intermediate base 30, letting the connecting plate 422 restrictively positioned by the two recessed insert holes 33 and permitting the rear shaft 42 of the conveying device 40 only to move back and forth horizontally. The conveying belt 43 formed with a rough surface 431 with high friction coefficient is fitted around the intermediate base 30 and passes on both the front shaft 41 and the rear shaft 42.

The upper base 50 assembled on the upper ends of the four threaded rods 21 is provided at a preset location with a rotary handle 51, which can be turned to actuate the threaded rods 21 to rotate and engage with the threaded holes 31 so as to adjust the distance between the upper base 50 and the intermediate base 30, with the upper base 50 moved up and down. The upper base 50 is further provided at a preset location with a knife shaft 52 pivotally connected with a planing knife 53. The knife shaft 52 has one end extending out one side of the upper base 50 and connected with the motor of the planing table 20 so that the planing knife 53 can be driven by the motor to rotate and carry out planing a work. The knife shaft 52 has the other end extending out of the other side of the upper base 50 and connected with the transmission device 60. In addition, the upper base 50 is pivotally connected with two rollers 54 respectively positioned at the front and the rear side of the planing knife 53 and each roller 54 has its upper side provided with an elastic member 541 for elastically pressing the roller 54 downward.

The transmission device 60 is composed of a gear set 61, a transmission shaft 62 and a transmission unit 63. The gear set 61 secured at one side of the upper base 50 consists of a knife shaft gear 611, a worm 612, a guide gear 613 and a worm gear 614. The knife shaft gear 611 is connected with the knife shaft 52 for producing power through the knife shaft 52. The guide gear 613 is firmly fitted on the end of the worm 612 and engaged with the knife shaft gear 611 for actuating the worm 612 to rotate, and the worm gear 614 is engaged with the worm 612. The transmission shaft 62 is firmly fitted in the center of the worm gear 614 and bored with an axial slide groove 621 and the worm gear 614 is secured in the slide groove 621 by a connecting key 6141.

The transmission unit 63 is fixed at one side of the intermediate base 30 and positioned under the gear set 61, consisting of a transmission bevel gear 631, a driven bevel gear 632 and a transmission gear 633. The transmission bevel gear 631 is pivotally fitted on the transmission shaft 62 and restrictively positioned in the slide groove 621 by a connecting key 6311, able to move axially and rotate with the transmission shaft 62. The driven bevel gear 632 is engaged with the transmission bevel gear 631 and connected with the transmission gear 633 positioned at the outer side of the transmission unit 63. The transmission gear 633 is connected with the driven gear 412 of the conveying device 40 by means of a chain 64.

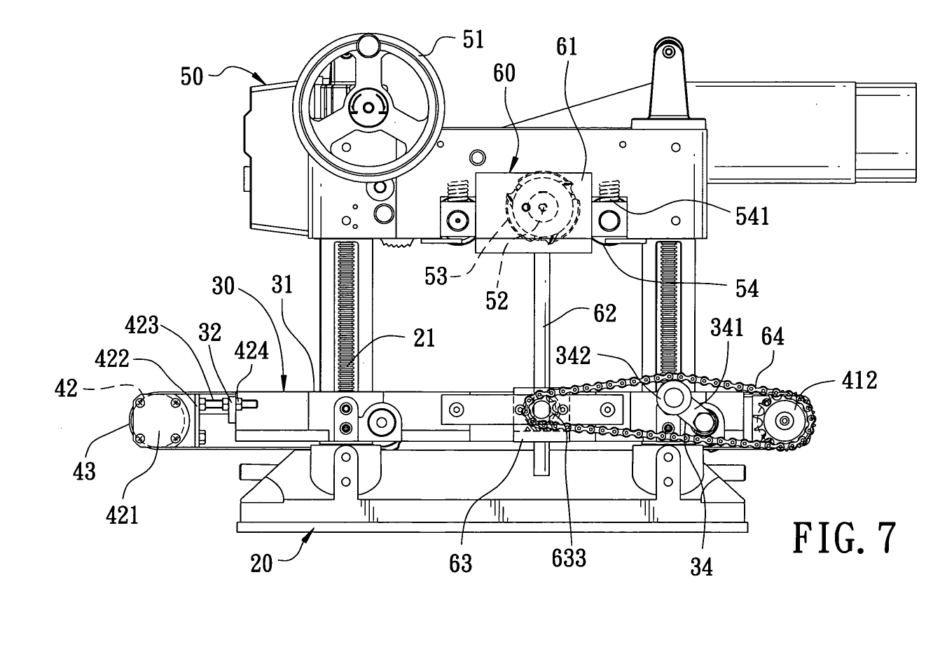

To carry out planing, as shown in FIGS. 3 and 7, the rotary handle 51 is first turned around to adjust the distance between the intermediate base 30 and the upper base 50, and at this time the transmission unit 63 will be moved up and down together with the intermediate base 30 and the transmission bevel gear 631 inside the transmission unit 63 will be axially moved on the transmission shaft 62. Next, the knife shaft 52 is driven to rotate and actuate the planing knife 53 to rotate and carry out planing a work, and simultaneously the knife shaft gear 611 connected with the end of the knife shaft 52 will actuate the gear set 61 to rotate and drive the transmission shaft 62 to rotate. At this time, the transmission bevel gear 631 pivotally fitted on the transmission shaft 62 will be actuated by the transmission shaft 62 to rotate and drive the transmission gear 633 and the chain 64 to rotate. Synchronously, the chain 64 will actuate the driven gear 412 to rotate and drive the front shaft 41 and the conveying belt 43 to operate. Subsequently, a work piece is pushed in from the front end of the intermediate base 30 and conveyed to the rear end of the intermediate base 30 by the frictional force produced by the rough surface of the conveying belt 43. In the meantime, the rollers 54 of the upper base 50 will be actuated by the moving work to rotate and, by the downward elastic press force of the elastic members 541, compress the work on the conveying belt 43 to enable the work piece to be planed smoothly. Further, the distance between the rear shaft 42 of the conveying device 40 and the intermediate base 30 as well as the tightness of the conveying belt 43 can be adjusted by adjusting the position of the rear shaft 42 by means of the two adjusting rods 423 on the connecting plate 422. Furthermore, the tightness of the chain 64 can also be adjusted by adjusting the position of the idle wheel unit 34.

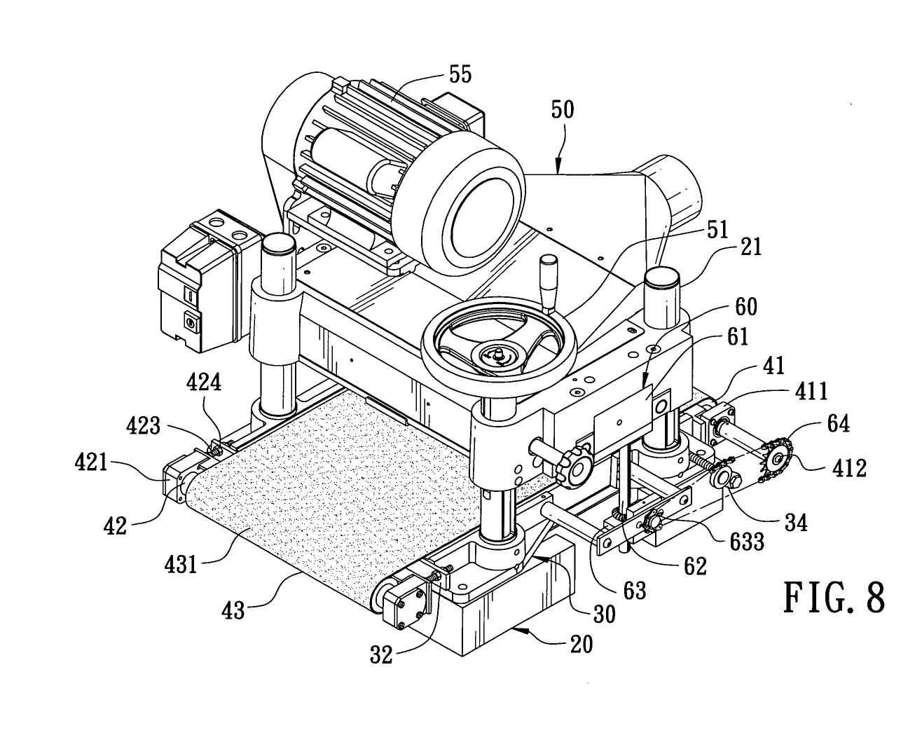

A second preferred embodiment of a work piece feeding and conveying mechanism for a planing machine in the present invention, as shown in FIG. 8, has the same function as that described in the first preferred embodiment. In the second preferred embodiment, the intermediate base 30 is secured on the planing table 20 and the rotary handle 51 is turned to control the position of the upper base 50 on the threaded rods 21 for adjusting the processing distance between the upper base 50 and the intermediate base 30. The knife shaft 52 is driven to operate by a motor 54 positioned above the knife shaft 52, and the gear set 61 fixed on the upper base 50 will be moved together with the upper base 50. Since the transmission shaft 62 is secured on the worm gear 614 of the gear set 61; therefore, when the gear set 61 is moved together with the upper base 50, the transmission shaft 62 will be moved together with the gear set 61. Additionally, since the transmission unit 63 is firmly fitted at the outer side of the intermediate base 30, therefore, when the upper base 50 is moved, the transmission shaft 62 will slide in the transmission bevel gear 631 and actuate the transmission bevel gear 631 to rotate.

As can be understood from the above description, this invention has the following advantages.

1. The conveying belt of the conveying device has its surface contacting with the surface of a work, able to apply force evenly, conveying the work smoothly and carry out planing process precisely.

2. The rollers pivotally connected with the planing knife are actuated to rotate by the moving work piece so it is needless to additionally provide power source or a gear unit for driving them, lowering cost in producing and repairing a planing machine and elevating market competitive force.

3. The transmission device is directly actuated to operate by the knife shaft, so it is needless to provide an extra power.

While the preferred embodiments of the invention have been described above, it will be recognized and understood that various modifications may be made therein and the appended claims are intended to cover all such modifications that may fall within the spirit and scope of the invention.

I claim:

1. A work feeding and conveying mechanism for a planing machine, said mechanism comprising a planing table, an intermediate base, a conveying device, an upper base and a transmission device, the planing distance between said intermediate base and said upper base able to be adjusted:
said planing table formed with a flat upper surface, said intermediate base and said upper base orderly assembled on said planing table;
said intermediate base assembled on said planing table, said conveying device positioned on said intermediate base, said conveying device composed of a front shaft, a rear shaft and a conveying belt, said front shaft secured at the front end of said intermediate base, said front shaft having one end extending outward and assembled thereon with a driven gear connected with said transmission device, said rear shaft pivotally connected with the rear end of said intermediate base, said rear shaft able to be shifted horizontally for a preset distance, said conveying belt formed with a rough surface with high friction coefficient, said conveying belt mounted around said intermediate base and passing on said front shaft and said rear shaft, the tightness of said conveying belt able to be adjusted by said rear shaft, said front shaft actuated by said transmission device to rotate together with said rear shaft;
said upper base positioned over said intermediate base, said upper base pivotally connected with a knife shaft, said knife shaft having its opposite ends respectively extending out of the opposite sides of said upper base, said knife shaft having one end connected with a motor, said knife shaft fixed with a planing knife in said upper base, said planing knife actuated by said knife shaft to rotate and carry out planing a work, said knife shaft having the other end connected with said transmission device; and
said transmission device composed of a gear set, a transmission shaft and transmission unit, said gear set secured at one side of said intermediate base and driven to rotate by said knife shaft, said gear set having its lower side coupled with said transmission shaft, said transmission shaft able to drive said transmission set to rotate, said transmission unit positioned at a preset location of said intermediate base, said transmission unit rotated together with said transmission shaft and provided at the outer side with a transmission gear connected with said driven gear of said intermediate base.

2. The work feeding and conveying mechanism for a planing machine as claimed in claim 1, wherein said front shaft of said conveying device is secured on said intermediate base by means of two bearing supports and said driven gear is pivotally connected with said transmission gear by a chain, an idle wheel unit pivotally disposed at the inner side of said chain, said idle wheel unit composed of an adjusting rod and an idle wheel, said adjusting rod having one end pivotally connected with said intermediate base and the other end connected with said idle wheel.

3. The work feeding and conveying mechanism for a planing machine as claimed in claim 1, wherein said intermediate base has its rear side fixed with a projecting block having its opposite ends respectively bored with a through hole and its central portion bored with two slide holes, said intermediate base further having its rear wall bored with two recessed insert holes aligned to said two slide holes of said projecting block, said rear shaft of said conveying device having its opposite ends respectively positioned on two bearing supports, a connecting plate secured at the front side of said two bearing supports, said connecting plate having its opposite ends respectively provided with an adjusting rod inserted through said through hole of said projecting block, said connecting plate having its front lower portion fixed with two slide rails vertically extending forward and respectively inserted in said two insert holes of said intermediate base.

4. The work feeding and conveying mechanism for a planing machine as claimed in claim 1, wherein said gear set of said transmission device is composed of a knife shaft gear, a worm, a guide gear and a worm gear, said knife shaft gear secured on said knife shaft to rotate together, said worm having one end fitted with said guide gear and engaged with said knife shaft gear, said worm able to actuate said worm gear to rotate, said worm gear having its lower side pivotally connected with said transmission shaft.

5. The work feeding and conveying mechanism for a planing machine as claimed in claim 1, wherein said transmission set is composed of a transmission bevel gear, a driven bevel gear and a transmission gear, said transmission bevel gear pivotally fitted on said transmission shaft, said transmission bevel gear engaged with said driven bevel gear to rotate together, said driven bevel gear having its outer side protruding outward and connected with said transmission gear.

6. The work feeding and conveying mechanism for a planing machine as claimed in claim 4 or 5, wherein said transmission shaft is axially bored with a slide groove and said worm gear is pivotally provided with a connecting key matching with said slide groove of said transmission shaft, said transmission bevel gear also pivotally provided with a connecting key matching with said slide groove of said transmission shaft.

7. The work feeding and conveying mechanism for a planing machine as claimed in claim 1, wherein said knife shaft has its opposite sides respectively and pivotally connected with a roller, said two rollers having their upper sides respectively disposed with an elastic member to enable said rollers to produce a downward elastic pressing force.
